(19) United States
(12) Patent Application Publication
(10) Pub. No.: US 2005/0105753 A1
(43) Pub. Date: May 19, 2005

(54) Equaliser, or phase plug, for electro-acoustic transducers

(76) Inventors: Andrea Manzini, Reggio Emilia (IT); Stefano Prati, Rubiera (Reggio Emilia) (IT); Umberto Storchi, Suzzara (Mantova) (IT)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/499,658

(22) PCT Filed: Apr. 22, 2003
(86) PCT No.: PCT/IT03/00252

(30) Foreign Application Priority Data
Oct. 31, 2002 (IT) PR2002A000064

(51) Int. Cl. H04R 1/02; H04R 1/20

(52) U.S. Cl. 381/343; 381/345

(57) ABSTRACT

Equaliser (4) or phase plug, for electro-acoustic transducers (1), having at least a central hole (40), and or a first series of openings (41), or slots, in the from of concentric rings, coaxial to an axis (4a) of symmetry of the phase plug (4). Said phase plug is characterised in that it has at least a second series of radial slots (42) positioned externally to said hole (40) or to said first series of slots (41). In the phase plug (4) has a third series of radial slots (43) interposed between said first and second series (41;42).

### TECHNICAL FIELD AND BACKGROUND ART

The present invention relates to an equaliser, or phase plug, for electro-acoustic transducers, having at least a central hole and/or a first series of openings, or slots, in the form of concentric rings, coaxial to an axis of symmetry of the equaliser.

As is well known, equalisers, better known as “Phase Plug” (PP), are inserted within electro-acoustic transducers designed for sound reproduction, commonly known by the term “Compression Drivers” (CD).

A CD comprises a static magnetic circuit with axial symmetry, obtained using a permanent magnet, for instance with annular shape, interposed between two plates made of ferromagnetic material, one of which, called central pole, has a holed expansion which is inserted in through cavities of the magnet and of the other plate, which is thus annularly positioned relative to said expansion.

Between the expansion of the central pole and the annular plate is obtained an annular air gap where the field lines of the magnetic circuit are concentrated.

The movable part of the CD is constituted by a cylindrical coil and by a membrane connected thereto.

Combining the movable part with the magnetic circuit, the coil is positioned exactly at the centre of the air gap.

By applying a sinusoidal electrical signal to the coil, an alternating motion of the membrane is obtained in the direction of the axis of the structure with the consequent creation of sound waves, which are propagated towards the output of the CD by means of the hole present in the expansion of the central pole.

Normally, CDs are coupled to acoustic horns which allow to amplify and focus the sound within a limited region of space.

The PP has a hemispherical surface and is normally positioned inside the central cavity of the expansion of the central pole, through which sound propagates towards the output of the CD.

The PP has a series of openings, called “slots”, obtained on the spherical surface of the PP adjacent to the membrane. The slots end on the opposite side of the PP relative to the membrane are face the output of the CD.

By appropriately dimensioning the slots, it is possible to increase the sound pressure level at the output of the CD and simultaneously to eliminate all interference problems, obtaining at the output of the CD wave front that is coherent throughout the operating band of the component.

During the development and production stage it is extremely important to assemble the CD in such a way that the PP faithfully reproduces the spherical shape of the membrane.

A first type of PP provides for a series of slots in the form of concentric annular rings, symmetrical relative to the axis of symmetry of the CD.

There are various criteria for determining the number of slots, their position on the hemispherical surface adjacent to the membrane and the air passage area. In particular, a known criteria is Bob Smith's, subsequently amplified by Francher Murray, wherein a theoretical study has also been presented regarding the removal of the stationary waves generated between membrane and PP.

The PP provided with slots in the form of concentric rings described above have some drawbacks.

First of all, said PPs are extremely costly and complicated to assemble, since they must be constructed of multiple pieces (generally, “n” if “n” is the number of slots). This makes it particularly critical to control tolerances on the distance between membrane and spherical surface of the PP.

Secondly, such an arrangement of the slots generates resonance phenomena which are difficult to eliminate, especially at high frequencies (over 10 kHz).

A second type of PP currently on the market has slots in the form of rectangles or trapezoids, positioned in radial direction relative to the axis of symmetry of the transducer.

This arrangement of the slots allows to eliminate the resonance typical of the first type of PP.

All other parameters being equal, the PP with radial symmetry allows to increase the extension of the reproduced sound range, but at the same time it also produces a loss of sound pressure.

Therefore, although a PP with radial symmetry has an undoubted advantage in terms of construction simplicity, it has a disadvantageous loss of efficiency, especially at high frequencies.

There are other types of PP; they are less widely used, but they are of some interest nonetheless.

In particular, PPs are known which are constituted by a series of variously distributed circular slots, as well as PPs comprising slots arranged in parallel, according to vertical or horizontal directions.

### DISCLOSURE OF THE INVENTION

An aim of the present invention is to eliminate the aforesaid drawbacks making available an equaliser, or phase plug, for electro-acoustic transducers that is able to move beyond the audible band any resonance generated by the slots.

Another aim of the present invention is to propose a phase plug that prevents possible phase cancellations.

A further aim of the present invention is to make available a phase plug that eliminates high frequency resonance and simultaneously prevents the generation of stationary waves between PP and membrane.

Yet another aim of the present invention is to make available a phase plug that can be made in a single piece, within the context of a simple, rational and reliable constructive solution.

Said aims are fully achieved by the phase plug of the present invention, which is characterised by the contents of the claims set out below and in particular in that it has at least a second series of radial slots positioned externally to said hole or to said first series of slots.

### BEST MODE FOR CARRYING OUT OF THE INVENTION

This and other features shall become more readily apparent from the description that follows of a preferred embodiment illustrated, purely by way of non limiting example, in the accompanying drawing tables, in which:

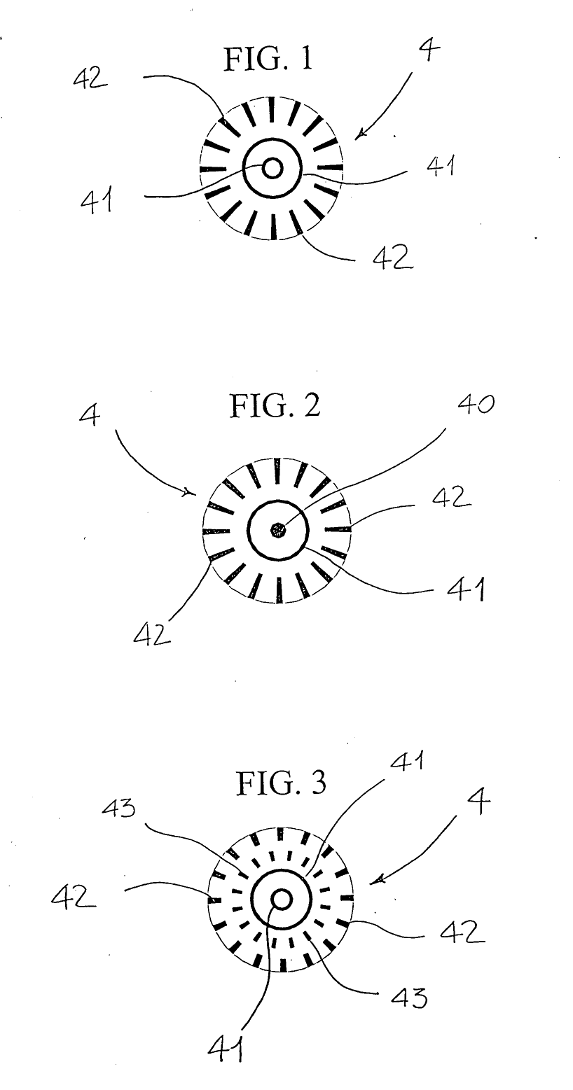

FIG. 1 shows a top view of a first embodiment of a phase plug according to the invention

FIG. 2 shows a top view of a second embodiment of a phase plug according to the invention;

FIG. 3 shows a top view of a third embodiment of a phase plug according to the invention.

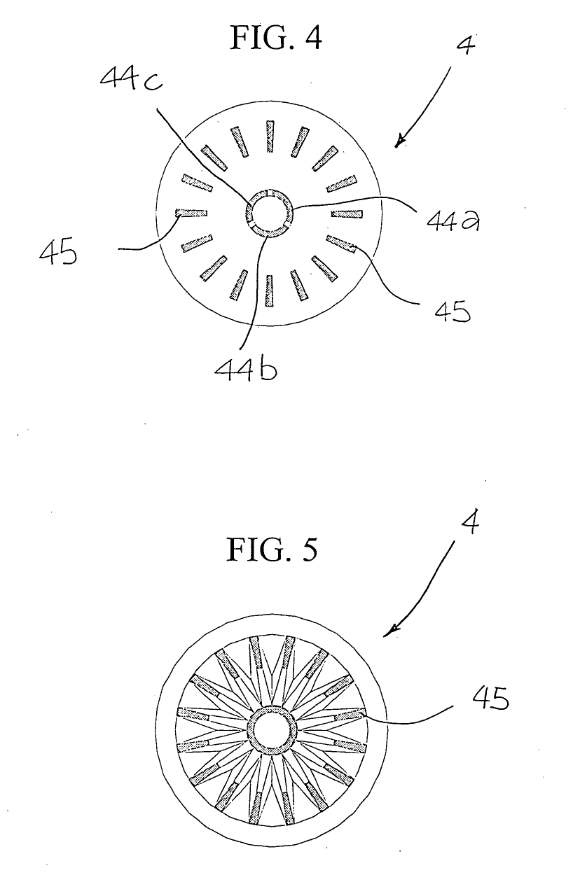

FIGS. 4 and 5 respectively show a top and a bottom enlarged view of a fourth embodiment of a phase plug according to the invention;

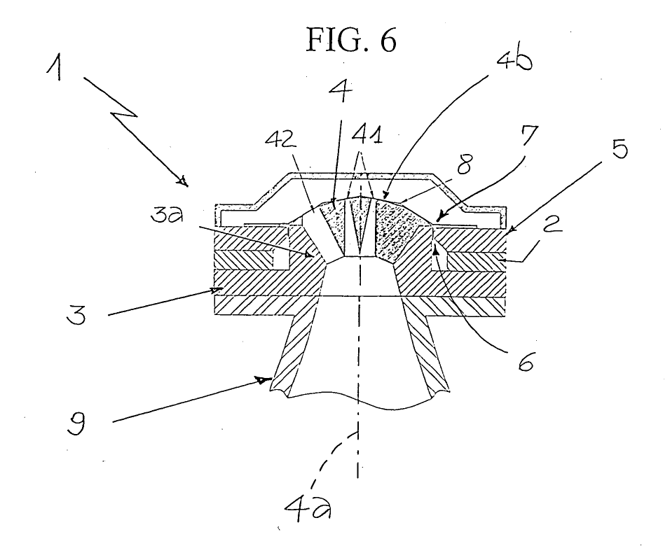

FIG. 6 shows a section view of an electro-acoustic transducer comprising a phase plug according to the invention.

With reference to FIG. 6, the electro-acoustic transducer is globally indicated with the number 1 and comprises a permanent magnet 2 with annular shape and centrally provided with a through hole.

In accordance with a first embodiment variation, not shown herein, the magnet 2 may be constituted by a plurality of annular segments, each of which is a permanent magnet.

In accordance with a second embodiment variation, not shown herein, the magnet 2 may be obtained by means of a plurality of permanent magnets, each having preferably circular section.

The transducer 1 comprises a first plate 3, or central pole, positioned in contact with the magnet 2 and having an expansion 3a so shaped as to be inserted in the through hole of the magnet itself. The expansion 3a has a cavity shaped complementarily to a phase plug 4, in order to receive it and maintain it in position.

If the second embodiment variation described above is used, the permanent magnets will be arranged peripherally to the expansion 3a, taking care that the centre of the section of each magnet is positioned on a circumference that is substantially coaxial to the central pole 3a.

At the side opposite the first plate 3 relative to the magnet 2 is present a second plate 5, also positioned in contact with the permanent magnet. The second plate 5 defines an air gap 6 in combination with the expansion 3a of the central pole 3.

The transducer 1 is provided with a coil 7 positioned coaxially to the expansion 3a of the central pole and immersed in the air gap 6. The coil can move with alternating motion parallel to an axis of symmetry 4a of the phase plug 4.

To the coil 7 is connected a membrane 8, typically hemispheric, which covers, preferably without touching it, an upper surface 4b of the phase plug 4. The vibration of the membrane, caused by the alternating motion of the coil 7, generates acoustic waves which reproduce an electrical signal transmitted to the coil by means of an electronic circuit associated thereto.

The phase plug 4 is provided with at least a central hole 40 (see FIG. 2) and/or with a first series of openings, or slots, 41 (see FIGS. 1, 2 and 3), in the form of concentric rings, coaxial to the axis of symmetry 4a of the phase plug.

The phase plug is originally provided with a second series of radial slots 42 positioned externally to said hole and/or to said first series of slots 41.

With particular reference to the embodiment shown in FIG. 3, the phase plug 4 has a third series of radial slots 43 interposed between said first and second series 41, 42.

In the embodiments shown in FIGS. 1, 2 and 3, the second series of slots 42 is obtained in correspondence with the perimeter of the phase plug. Specifically, said perimeter is defined by the lateral walls of the expansion 3a of the central pole. In particular, said lateral walls serve as external closure surfaces for the slots.

With reference to FIGS. 4 and 5, the phase plug is provided with an annular central slot 44 comprising three annular segments 44a, 44b, 44c, necessary to provide mechanical support to the central part of the phase plug.

The phase plug is further provided with a series of radial slots 45 external to the central slot 44 and preferably with trapezoidal shape.

In the embodiment described above, the open surface of the phase plug 4 reserved for the passage of air is preferably about 1/10 of the hemispherical surface of the membrane.

Moreover, the slots were positioned in such a way that to equal portions of membrane correspond slots of equal dimensions.

The transducer 1 is provided with an acoustic horn 9 connected to the central pole 3, at the side opposite the phase plug with respect to the magnet 2. Said acoustic horn is necessary to amplify and focus the sound within a limited region of space.

The invention achieves important advantages.

First of all, with respect to a phase plug provided with slots in the form of concentric rings, coaxial to the axis of the phase plug, a PP according to the invention allows to eliminate resonance present at high frequency and offers a more linear and more easily equalised response.

Secondly, with respect to phase plugs having exclusively radial slots, a PP according to the invention, in addition to offering a more linear response, also has high acoustic efficiency, especially in the frequency band above 7 kHz.

An additional advantage is given by the fact that such a PP not only eliminates high frequency resonance but also prevents the generation of stationary waves between the phase plug and the membrane.

Advantageously, since a PP in accordance with the presence invention can be constructed in a single piece, it is economical and simple to fabricate.

Yet another advantage of the present invention is given by the fact that a PP according to the invention prevents possible phase cancellations.

1. Equaliser (4), or phase plug, for electro-acoustic transducers (1), having at least a central hole (40) and/or a first series of openings (41), or slots, in the form of concentric rings, coaxial to an axis (4a) of symmetry of the phase plug (4), characterised in that it has at least a second series of radial slots (42) positioned externally to said hole (40) or to said first series of slots (41).

2. Phase plug as claimed in claim 1, characterised in that it has a third series of radial slots (43) interposed between said first and second series (41;42).

3. Phase plug as claimed in claims 1 or 2, characterised in that it is associated to an electro-acoustic transducer (1), comprising:
at least a permanent magnet (2) of annular shape and centrally provided with a through hole;
at least a first plate (3), or central pole, positioned in contact with the magnet (2) and having an expansion (3a) so shaped as to be inserted in the through hole of the magnet (2) itself, said expansion (3a) having a cavity shaped complementarily to the phase plug (4) to receive it;
at least a second plate (5) in contact with the magnet (2) at the opposite side with respect to the first plate (3) and defining an air gap (6) with said expansion (3a);
at least a coil (7) coaxial to the expansion (3a), immersed in the air gap (6) and movable parallel to an axis (4A) of symmetry of the phase plug (4);
at least a movable membrane (8) positioned on an upper surface (4b) of the phase plug (4) and connected to the coil (7).

4. Phase plug as claimed in claims 1 or 2, characterised in that it is associated to an electro-acoustic transducer (1) comprising:
at least a permanent magnet constituted by a plurality of annular segments delimiting a through hole;
at least a first plate (3), or central pole, positioned in contact with the magnet and having an expansion (3a) so shaped as to be inserted in the through hole of the magnet itself, said expansion (3a) having a cavity shaped complementarily to the phase plug (4) to receive it;
at least a second plate (5) in contact with the magnet at the opposite side with respect to the first plate (3) and defining an air gap (6) with said expansion (3a);
at least a coil (7) coaxial to the expansion (3a), immersed in the air gap (6) and movable parallel to an axis (4) of symmetry of the phase plug (4);
at least a movable membrane (8) positioned on an upper surface (4b) of the phase plug (4) and connected to the coil (7).

5. Phase plug as claimed in claims 1 or 2, characterised in that it is associated to an electro-acoustic transducer (1), comprising:
a plurality of permanent magnets, each having circular section with the centre positioned on a circumference, said permanent magnets delimiting a through cavity;
at least a first plate (3), or central pole, positioned in contact with the magnets and having an expansion (3a) so shaped as to be inserted in the through hole delimited by the magnets, said expansion (3a) having a housing shaped complementarily to the phase plug (4) to receive it;
at least a second plate (5) in contact with the magnets at the opposite side with respect to the first plate (3) and defining an air gap (6) with said expansion (3a);
at least a coil (7) coaxial to the expansion (3a), immersed in the air gap (6) and movable parallel to an axis (4A) of symmetry of the phase plug (4);
at least a movable membrane (8) positioned on an upper surface (4b) of the phase plug (4) and connected to the coil (7).

6. Phase plug as claimed in claim 3, characterised in that the second series of radial slots (42) is obtained in correspondence with the perimeter of the phase plug (4), said perimeter being defined by lateral walls of the expansion (3a) of the first plate (3), or central pole.

7. Phase plug as claimed in claim 4, characterised in that the second series of radial slots (42) is obtained in correspondence with the perimeter of the phase plug (4), said perimeter being defined by lateral walls of the expansion (3a) of the first plate (3), or central pole.

8. Phase plug as claimed in claim 5, characterised in that the second series of radial slots (42) is obtained in correspondence with the perimeter of the phase plug (4), said perimeter being defined by lateral walls of the expansion (3a) of the first plate (3), or central pole.
